(19) United States
(12) Patent Application Publication
(10) Pub. No.: US 2018/0247327 A1
(43) Pub. Date: Aug. 30, 2018

(54) STAFF PROMOTIONS WITH E-TICKETING BACKGROUND

(71) Applicant: PANASONIC INTELLECTUAL PROPERTY MANAGEMENT CO., LTD., OSAKA (JP)

(72) Inventors: John CRONIN, Bonita Springs, FL (US); Jonathan T. GOGUEN, Brookline, NH (US); Joseph BODKIN, South Burlington, VT (US); Yoshihiro OKUMURA, Osaka (JP)

(21) Appl. No.: 15/906,715

(22) Filed: Feb. 27, 2018

Related U.S. Application Data
(60) Provisional application No. 62/464,665, filed on Feb. 28, 2017.

(51) Int. Cl. G06Q 30/02

(52) U.S. Cl. CPC G06Q 30/0214; G06Q 30/0235

(57) ABSTRACT

An exemplary system for distributing promotions in association with digital tickets may include a staff device with memory that stores information regarding at least one attraction and a reward associated with a promotion, and a communication interface that sends an offer to one or more communications devices regarding at least one of the promotions, as well as a server that receives information from a communication devices of one of the guests, analyzes the received information to determine whether the guest has met a condition of the promotion at the attraction within a predetermined time and whether a staff member of the staff device has met a condition of one or more staff promotions, and transmits a notification to the communication device when the reward is achieved and a notification to the staff device when a staff reward is achieved by the staff member.

### CROSS-REFERENCE TO RELATED APPLICATION

The present disclosure claims benefit of Provisional Patent Application No. 62/464,665, filed Feb. 28, 2017, the contents of which are incorporated by reference in their entirely.

### TECHNICAL FIELD

The present disclosure generally relates to digital ticketing. In particular, the present disclosure relates to customer service distribution of promotions in association with digital tickets.

### DESCRIPTION OF THE RELATED ART

Many theme parks, resorts, and similar types of service providers may wish to incentivize certain activities by their guests during their visit. Previously known incentive programs merely provide points based on verified activities and rewards for reaching certain benchmarks in terms of points. Some activities—such as online mailing list subscription, purchases, or reservations—may be easier to track and verify, because the user may be required to enter identification information (e.g., name, address, payment information).

Presently available loyalty programs or promotional campaigns may rely, however, either on cumbersome or time-consuming systems requiring individual in-person verification (e.g., obtaining stamps or proof). While each proof may individually not be time-consuming to obtain, obtaining multiple stamps over the course of a day when there may be numerous others doing the same may be extremely time-consuming cumulatively. A system that is cumbersome or time-consuming will lack participation, especially because individuals visiting a venue for a limited time period do not wish to waste their time.

Alternatively, self-verification systems are prone to being gamed, which discourages the service provider from offering prizes or awards that may either be expensive or otherwise undesirable to provide at large numbers. As a result, the guests may be less incentivized to participate if the prize for doing so is not special in some way.

There is, therefore, a need in the art for improved systems and methods for distributing promotions in association with digital tickets.

### SUMMARY

Embodiments of the present disclosure include distributing promotions in association with digital tickets. An exemplary system for distributing promotions in association with digital tickets may include a staff device with memory that stores information regarding at least one attraction and a reward associated with a promotion, and a communication interface that sends an offer to one or more communications devices regarding at least one of the promotions, as well as a server that receives information from a communication devices of one of the guests, analyzes the received information to determine whether the guest has met a condition of the promotion at the attraction within a predetermined time and whether a staff member of the staff device has met a condition of one or more staff promotions, and transmits a notification to the communication device when the reward is achieved and a notification to the staff device when a staff reward is achieved by the staff member.

### BRIEF DESCRIPTION OF THE DRAWINGS

FIG. 1 illustrates an exemplary network environment in which a system for distributing promotions in association with digital ticketing may be implemented.

FIG. 2 is a flowchart illustrating an exemplary method performed by a staff device for distributing promotions in association with digital ticketing.

FIG. 3 is a flowchart illustrating an exemplary method performed by a user device for distributing promotions in association with digital ticketing.

FIG. 4 is a flowchart illustrating an exemplary method performed by an attraction network server in distributing promotions in association with digital ticketing.

FIG. 5 is a flowchart illustrating an exemplary method performed by a resort network server in distributing promotions in association with digital ticketing.

FIG. 6 illustrates an exemplary entry from a staff device database that may be used in a system for distributing promotions in association with digital ticketing.

FIG. 7 illustrates an exemplary entry from a user device database that may be used in a system for distributing promotions in association with digital ticketing.

FIG. 8 illustrates an exemplary entry from attraction network database that may be used in a system for distributing promotions in association with digital ticketing.

FIG. 9 illustrates an exemplary set of entries from a resort network user database that may be used in a system for distributing promotions in association with digital ticketing.

FIG. 10 illustrates an exemplary set of entries from a resort network user promotions database that may be used in a system for distributing promotions in association with digital ticketing.

FIG. 11 illustrates an exemplary set of entries from a resort network staff promotions database that may be used in a system for distributing promotions in association with digital ticketing.

FIG. 12A illustrates an exemplary entry from a resort network user reward database that may be used in a system for distributing promotions in association with digital ticketing.

FIG. 12B illustrates an exemplary entry from a resort network staff reward database that may be used in a system for distributing promotions in association with digital ticketing.

FIG. 13 illustrates an exemplary screenshot of a graphic user interface (GUI) used for input at a user device that may be used in a system for distributing promotions in association with digital ticketing.

FIG. 14 illustrates an exemplary screenshot of a graphic user interface (GUI) used for input at a staff device that may be used in a system for distributing promotions in association with digital ticketing.

FIG. 15 illustrates an exemplary screenshot of a graphic user interface (GUI) used for displaying user rewards at a user device that may be used in a system for distributing promotions in association with digital ticketing.

FIG. 16 illustrates an exemplary screenshot of a graphic user interface (GUI) used for displaying staff rewards at a staff device that may be used in a system for distributing promotions in association with digital ticketing.

FIG. 17 illustrates an exemplary promotion database including promotion information shared by staff devices.

FIG. 18 illustrates a flow chart for avoiding a staff device from distributing a promotion which is now not available and for allowing all staff devices to have the latest promotion information.

FIG. 19 illustrates a flow chart for controlling number of distribution for a promotion.

FIG. 20 illustrates a flow chart for controlling number of distribution for a promotion.

FIG. 21 illustrates an exemplary promotion database including promotion information for managing remaining tickets of the promotion.

FIG. 22 illustrates an exemplary computing system (i.e. user device) that may be used to implement an embodiment of the present invention.

### DESCRIPTION

Embodiments of the present disclosure include systems and methods for distributing promotions in association with digital tickets. An exemplary system for distributing promotions in association with digital tickets may include a staff device with memory that stores information regarding at least one attraction and a reward associated with a promotion, and a communication interface that sends an offer to one or more communications devices regarding at least one of the promotions, as well as a server that receives information from a communication devices of one of the guests, analyzes the received information to determine whether the guest has met a condition of the promotion at the attraction within a predetermined time and whether a staff member of the staff device has met a condition of one or more staff promotions, and transmits a notification to the communication device when the reward is achieved and a notification to the staff device when a staff reward is achieved by the staff member.

In general, staff members may be issued a staff device with a wireless communication interface (e.g., Bluetooth, RFID, NFC, etc.) that includes software executable to initiate loading of a digital incentive or promotion in association with an electronic ticket (e.g., Disney Magic Band) of a guest. Such a digital incentive specifies a ride/attraction that the guest can ride within a specific period of time to receive a reward (monetary or otherwise). In addition, if the guest successfully visits the attraction within the time allotted, the staff member who provided the guest with digital incentive may also receive a reward (e.g., monetary or otherwise). Such incentives may be used to influence guest movements to different locations within a resort in order to avoid overcrowding at certain locations, underutilization of other locations, and otherwise manage traffic, as well as engaging the guest in different aspects of the venue.

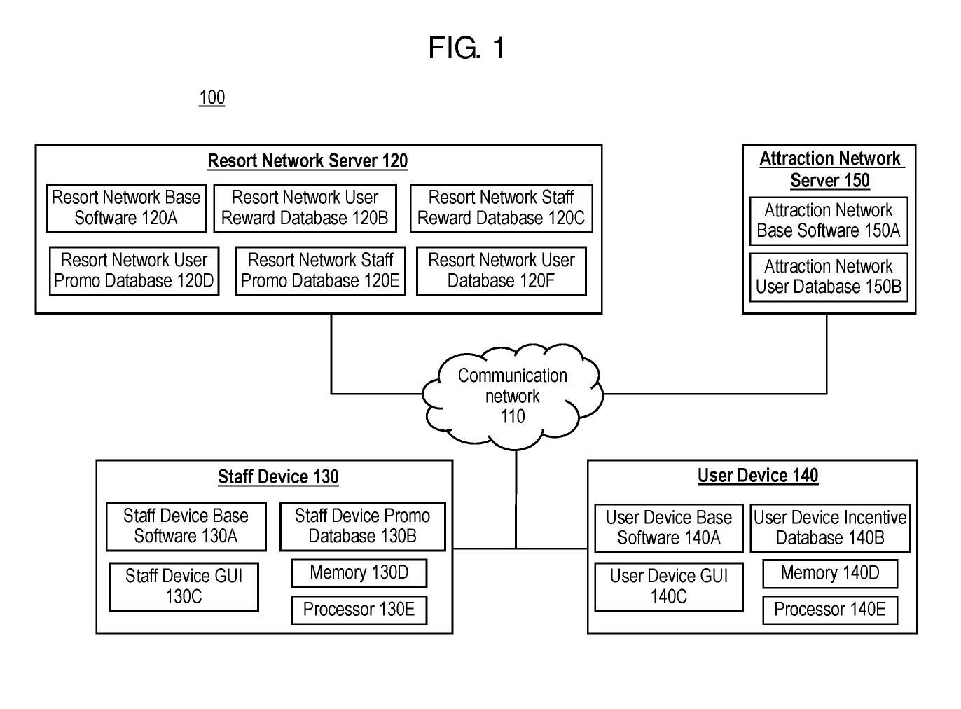

FIG. 1 illustrates an exemplary network environment 100 in which a system for tracking real-world activities may be implemented. Network environment 100 includes communication network 110 through which resort network server 120, staff device 130, user device 140, and an attraction network server 150 may communicate with each other.

Communication network 110 may be a local, proprietary network (e.g., an intranet) and/or may be a part of a larger wide-area network. The communications network 110 may be a local area network (LAN), which may be communicatively coupled to a wide area network (WAN) such as the Internet. The Internet is a broad network of interconnected computers and servers allowing for the transmission and exchange of Internet Protocol (IP) data between users connected through a network service provider. Examples of network service providers are the public switched telephone network, a cable service provider, a provider of digital subscriber line (DSL) services, or a satellite service provider. Communications network 110 allows for communication between the various components of network environment 100.

Resort network server 120 may include any type of server or other computing device as is known in the art, including standard hardware computing components such as network and media interfaces, non-transitory computer-readable storage (memory), and processors for executing instructions or accessing information that may be stored in memory. The functionalities of multiple servers may be integrated into a single server. Any of the aforementioned servers (or an integrated server) may take on certain clientside, cache, or proxy server characteristics. These characteristics may depend on the particular network placement of the server or certain configurations of the server.

Resort network server 120 may include resort network base software 120A, resort network user reward database 120B, resort network staff reward database 120C, resort network user promotion database 120D, resort network staff promotion database 120E, and resort network user database 120F. Resort network server base software 120A—which is embodied in non-transitory computer-readable storage media—may include instructions executable by a processor of the resort network server 120 to perform functions involved in distributing promotions in association with digital tickets.

Resort network user reward database 120B, resort network staff reward database 120C, resort network user promotion database 120D, resort network staff promotion database 120E, and resort network user database 120F maintain information in memory regarding user rewards, staff rewards, user promotions, staff promotions, and users/guests, respectively. Such information may be updated and retrieved as necessary to determine whether certain guests or staff members qualify for various promotions that are respectively available.

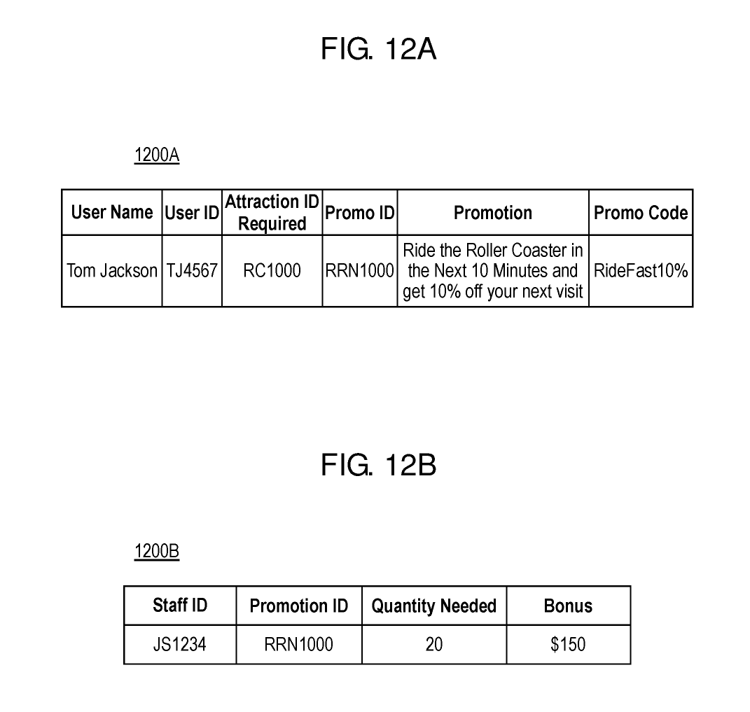

Staff device 130 may be any type of communication device known in the art, including general purpose computers, mobile phones, smartphones, personal digital assistants (PDAs), portable computing devices (e.g., laptop, netbook, tablets), desktop computing devices, handheld computing device, or any other type of computing device capable of communicating over communication network 110. Staff device 130 may be inclusive, for example, of a computing device such as described with respect to FIG. 12 herein.

Staff device 130 may include staff device base software 130A, staff device promotion database 130B, staff device GUI 130C, memory 130D, and processor 130E. Staff device base software 130A—which is embodied in non-transitory computerreadable storage media (e.g., memory 130D)—may include instructions executable by a processor 130E of the staff device 130 to distribute promotions to communication devices of guests. Such distribution may occur via email communication, SMS text message, Bluetooth connection, Internet connection, near field communication (NFC), radio frequency identification (RFID), and other communication connections and protocols known in the art.

Staff device promotion database 130B—which may also be stored in memory—may maintain information regarding a variety of available promotions. Such info′ illation regarding each promotion may include one or more parameters or conditions that must be met in order to qualify for an associated reward.

Staff device GUI 130C provides an interface by which a staff member operating the staff device 130 may enter information or request information. As such, staff device GUI may display a variety of fields that may be updated by the staff member, as well as various notifications that may be sent to the staff device 130. Staff device 130 may connect to the user device 140 and sends a promotion (e.g., as stored in the staff device promotions database 130B) to the user device 140.

User device 140 may be any type of communication device known in the art, including general purpose computers, mobile phones, smartphones, personal digital assistants (PDAs), portable computing devices (e.g., laptop, netbook, tablets), desktop computing devices, handheld computing device, or any other type of computing device capable of communicating over communication network 110. User device 140 may be inclusive, for example, of a computing device such as described with respect to FIG. 12 herein.

User device 140 may include user device base software 140A, user device incentive database 140B, user device GUI 140C, memory 140D, and processor 140E. User device base software 140A allows the user device 140 to perform the various functions described herein with respect to tracking incentives and rewards, as well as various related communications. For example, user device base software 140A—which may be downloaded from an online application store or otherwise installed onto user device 140—may include instructions regarding how to achieve certain available promotions and their associated rewards. The user base software 140A may further include instructions—embodied in non-transitory computer-readable storage media—on how to evaluate data related to received promotions. Such conditions may be defined by the service provider and may be based in part on details regarding the guest (e.g., registration, past visits, previous activity) that are associated with the digital ticket.

User device incentive database 140B may store all information relating to the visit to the venue, including that information used in and resulting from tracking of realworld activities representing progress towards a promotion in association with a digital ticket. Such user device incentive database 140B may include, for example, digital ticket information, registration details, historical information regarding the guest, previously tracked activities, previous rewards, etc. Such information may be used to create a calendar of events occurring in the venue, either related to unrelated to specific promotions.

User device GUI 140C may include any graphic user interface that requests and receive user input regarding preferences, registration, and other user-related information that may be used in tracking real-world activities in association with a digital ticket. Some of the information stored in user device database 140B may have come directly from user input by the guest via user device GUI 140C.

User devices 140 may also be configured to access data from other storage media, such as memory cards or disk drives as may be appropriate in the case of downloaded services. User device 140 may include standard hardware computing components such as network and media interfaces, non-transitory computer-readable storage (memory), and processors for executing instructions that may be stored in memory. The user device 140 may further include communication interfaces and network interfaces that allow for real-time communication channels to be established with other devices in the network environment 100.

The user device GUI 140C may receive input, which may then be stored in the user device incentive database 140B. Such input may include users entering promotion information themselves. Then the user device 140 may connect to the staff device 130 and receive information from the staff device promotions database 130B at the staff device 130. Information regarding promotions that had been maintained at the staff device promotions database 130B may then be stored in the user device incentive database 140B.

Once a promotion is received from a staff device 130, the user device 140 may then connect to the attraction network server 150 to report on progress toward the promotion. Such a report may include an identifier associated with the guest or user device 140, as well as information regarding attractions visited and various contextual details related to the same. The user device base software 140A may also continuously or intermittently poll for the presence of the resort server 120 (or a related device). Communications may be exchanged that allows for each device—resort network server 120 and user device 140—to have up-to-date information regarding guest activities, previously achieved rewards from past promotions, and progress toward other rewards in presently available promotions. Such data may likewise be stored in the user device database 140B. The user device 140 may then connects to the resort network server 120 and attraction network server 150 (via communication network 110)—either periodically or in response to certain benchmarks or triggers—to communicate information stored in user device database 140B and to update that information based on communications with resort network server 120 and attraction network server 150. For example, user device 140 may update information from the user device incentive database 140B, in order to confirm that that user is actually at the attraction that is in the promotion.

Attraction network server 150 may include any type of server or other computing device as is known in the art, including standard hardware computing components such as network and media interfaces, non-transitory computer-readable storage (memory), and processors for executing instructions or accessing information that may be stored in memory. The functionalities of multiple servers may be integrated into a single server. Any of the aforementioned servers (or an integrated server) may take on certain client-side, cache, or proxy server characteristics. These characteristics may depend on the particular network placement of the server or certain configurations of the server.

Attraction network server 150 may include base software 150A and a user database 150B. Attraction network server 150 may receive information sent over communication network 110 from user device 140, as well as resort network server 120. Such information—which may be associated with the digital ticket information of the guest and various promotions—may collectively be used to identify when a particular guest has qualified for certain rewards under certain promotions (e.g., a guest visiting a specified set of attractions and participated in a specified set of activities may win points redeemable toward a prize).

Attraction network base software 150A includes instructions embodied in non-transitory computer-readable storage media. Such instructions may include parameters regarding various promotional programs. Each promotional program—which may be specific to a particular service provider or one of their venues—may specify a set of conditions to be met before a reward is provided. Multiple rewards may be available, each associated with a different set of conditions. Rewards may be offered based on any combination of number of attractions visited, variety of attractions visited, time spent waiting in line, types of purchases made within the venue, and other factors reported to the resort network server 120.

The attraction network server 150 may connect to the user device 140 to receive information that had been maintained in the user device incentive database 140B. The attraction network server 150 may store information sent by the user device 140 in the attraction network user database 150B and then connect to the resort network server 120 to send the updated information as maintained in the attraction network user database 150B. The information that had been maintained in the attraction network database 150B may then be used to update information stored in the resort network user database 120F, which may then be compared to information in the resort network user promotions database 120D to identify progress towards promotions, which may be related or unrelated to third party advertising. This comparison may include determining the time the promotion was received and the time the user arrived at the attraction, as well as filtering the resort network user promotions database 120D based on a promotion ID. Such comparisons are used to determine whether the conditions of the promotion have been met (e.g., within a time range) so as to allow the proper reward be provided.

Information regarding the associated reward may then be extracted from the resort network user promotions database 120D and stored in the resort network user reward database 120F. The resort network 120 may then connects to the user device 140 and sends the information maintained in resort network user reward database 120B. Once the user device 140 connects to resort network server 120 and receives information that had been maintained in the resort network user reward database 120B, the information may be displayed on the user device GUI 140C.

The resort network base software 120A may further be executed to compare information maintained in the resort network user database 120F to the resort network staff promotions database 120E. This comparison may involve determining a number of promotions that been distributed by the staff device 130 and that actually incentivized guest behavior as indicated by guest activity information from user device 140. The information from the resort network user database 120F may be filtered based on the promotion IDs (e.g., of promotions distributed by the staff device 130), the staff ID (e.g., of the staff member that had been issued the staff device 130), and the time arrived. In addition, the comparison may further involve determining the count of the used promotions and comparing that to the information maintained in the resort network staff promotions database 120E to determine which bonus/reward the staff member achieved. The staff reward may then be extracted and stored in the resort network staff reward database 120C. The resort network server 120 may then connect to the staff device 130 and sends the information maintained in the resort network staff reward database 120C to the staff device 130. The staff device 130 is continuously polling for and connects to the resort network server 120. The staff device 130 receives and displays the information that had been maintained in the resort network staff reward database 120C on the staff device GUI 130C.

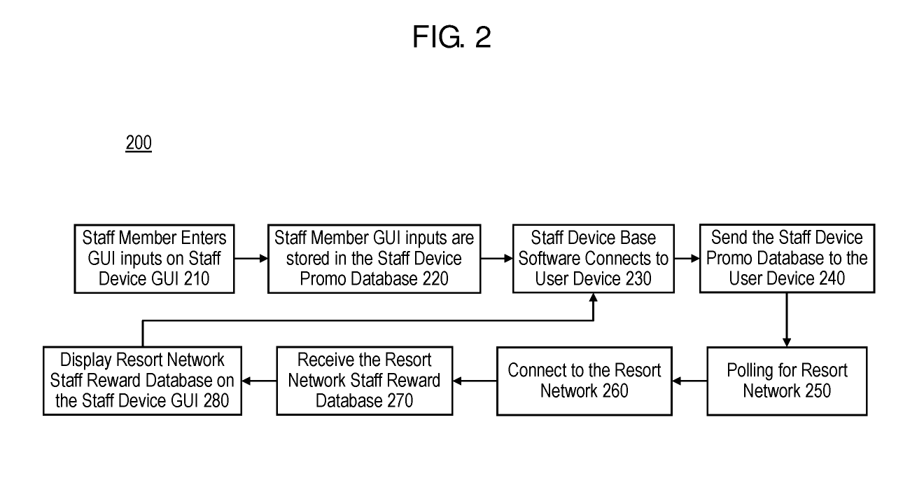

FIG. 2 is a flowchart illustrating an exemplary method 200 performed by a staff device 130 for distributing promotions in association with digital ticketing. Such a method 200 allows the staff device to distribute promotions to the guest user device 140 at an event/amusement park, as well as provide the staff member with rewards if there is certain amount of promotions successfully engage the guest.

In step 210, the staff device 130 receives input entered via the staff device GUI 130C. In step 220, such inputs may be stored in the staff device promotions database 130B. Then in step 230, the staff device 130 connects to the user device 140, and in step 240, the staff device 130 sends the information from the staff device promotions database 130B to the user device 140. Then in step 250, the staff device 130 may continuously poll for the resort network server 120, and in step 260, the staff device 130 connects to the resort network server 120. The staff device 130 receives information as stored in the resort network staff reward database 120C in step 270, which may then be displayed on the staff device GUI 130C in step 280. The method may then returns to step 230 in which the staff device 130 connects to the same or another user device 140 to distribute more or updated promotions.

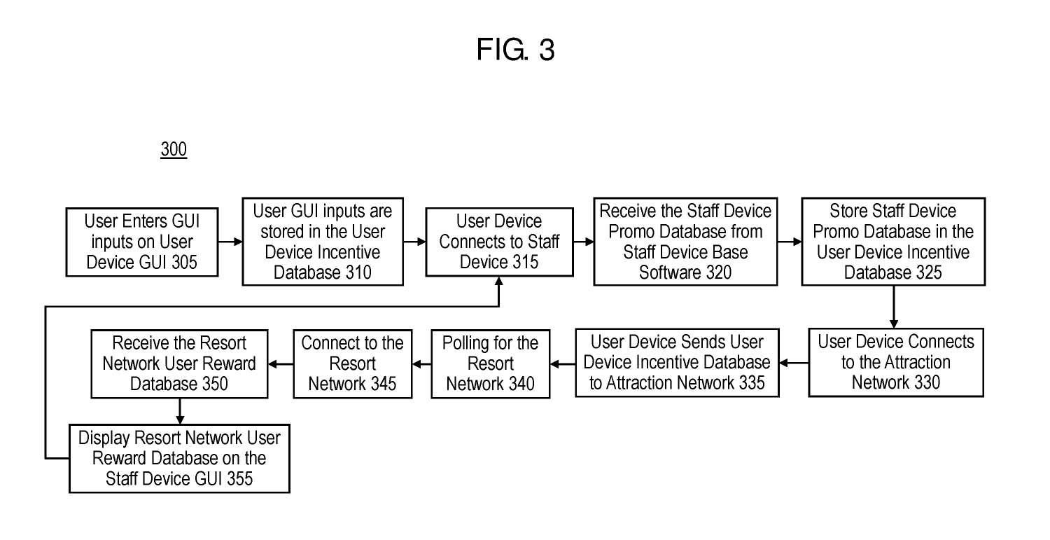

FIG. 3 is a flowchart illustrating an exemplary method 300 performed by a user device 140 for distributing promotions in association with digital ticketing. Such a method 300 may allow for the promotion to be sent from the staff device 140 to the user device 140, as well as pass user information to the attraction network server 150 for use in validating that the user was indeed at the attraction associated with the promotion.

In step 305, the user device GUI 140C receives user inputs, which may then be stored in the user device incentive database 140B in step 310. Then in step 315, the user device 140 connects to the staff device 130 and in step 320, receives information regarding promotions (as stored in the staff device promotions database 130B at the staff device 130). In step 325, the information that had been maintained in the staff device promotions database 130B may be stored in the user device incentive database 140B. In step 330, user device 140 connects to the attraction network server 150. In step 335, the user device 140 then sends the information maintained at the user device incentive database 140B to the attraction network server 150. In step 340, the user device 140 may continuously poll for the resort network server 120. Once the user device 140 connects to the resort network server 120 in step 345, receives the information that had been maintained in the resort network user reward database 120B in step 350, and then displays the reward information on the user device GUI 140C in step 355. The method may then return to step 305 in which the user device 140 connects to the same or another staff device 130 for a next or updated promotion.

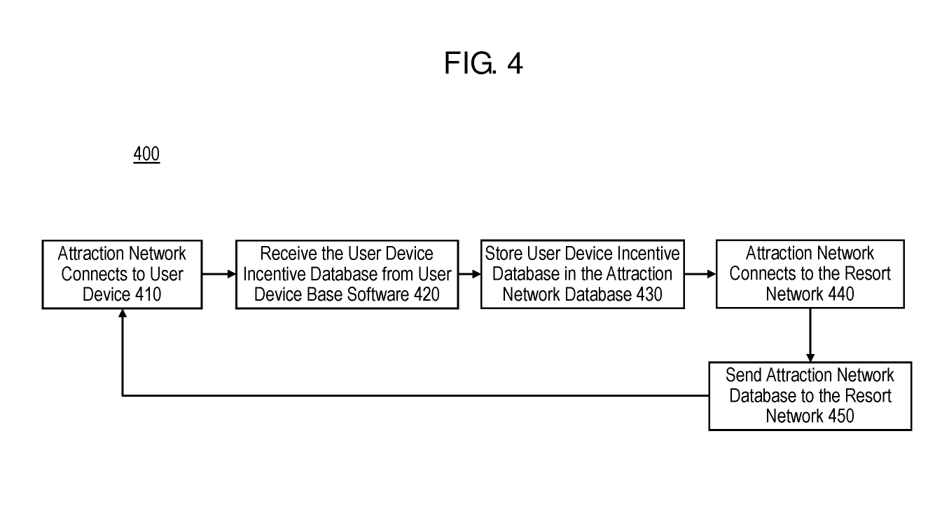

FIG. 4 is a flowchart illustrating an exemplary method performed by an attraction network server 150 in distributing promotions in association with digital ticketing. Such method 400 may be used to confirm that a user device 140 was present at an attraction associated with a promotion.

In step 410, the attraction network server 150 connects with the user device 140, and in step 420, the attraction network server 150 receives information that had been maintained at the user device incentive database 140B in the user device 140. In step 430, such information may be stored in the attraction network database 150B. In step 440, the attraction network server 150 may then connect to the resort network server 120, and in step 450, sends the information that had been maintained at attraction network database 150B to the resort network server 120. The method may then revert back to step 410 in which the attraction network server 150 connects to the user device 140 to receive updated information regarding progress toward the same or different promotion.

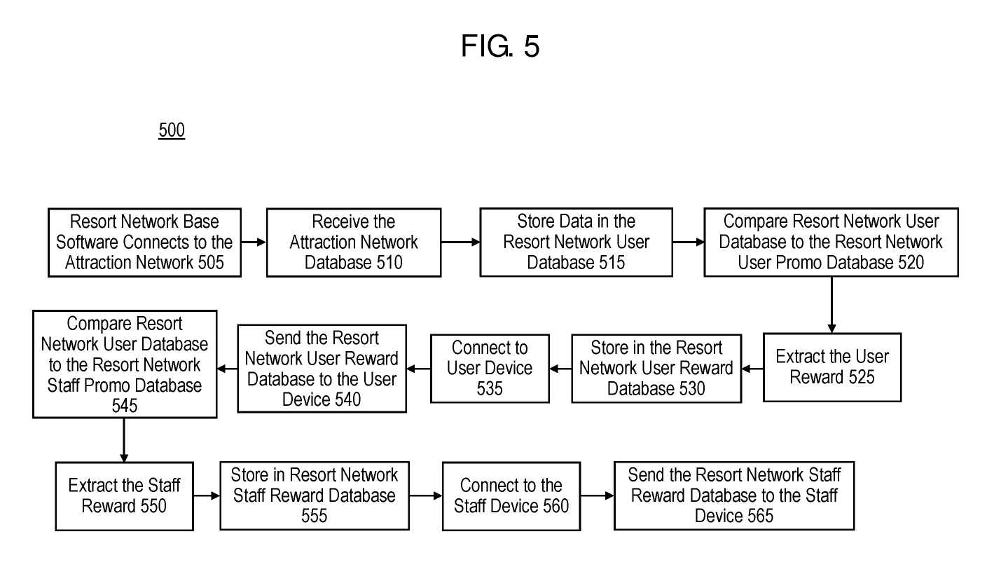

FIG. 5 is a flowchart illustrating an exemplary method 500 performed by a resort network server 120 in distributing promotions in association with digital ticketing. Such a method 500 may be used to compare user data in order to determine if the user has participated in the promotion, to provide the user with a reward upon meeting one or more conditions of the promotion, and to determine the number of promotions distributed by the staff device 130 that actually resulted in user participation so as to provide the staff with bonuses.

In step 505, the resort network server connects to the attraction network serve, and in step 510, the resort network server 120 receives information that had been maintained in the attraction network database 150B. In step 515, the information that had been maintained in the attraction network database 150B may then be stored in the resort network user database 120F, and in step 520, compared to the information in the resort network user promotions database 120D to determine, inter alia, the time the promotion was received and the time the user arrived at the attraction. Such a comparison may involve filtering the information maintained at the resort network user promotions database 120D by the promotion ID in order to determine the time range in which the user achieved conditions of the promotion so as to allow the proper reward be given. In step 525, the user reward is extracted from the resort network user promotion database 120D and in step 530, stored in the resort network user reward database 120B.

In step 535, the resort network sever 120 connects to the user device 140 and in step 540, sends the information that had been maintained in the resort network user reward database 120B. In step 545, the resort network 120 then compares the information maintained in the resort network user database 120F to the information maintained in the resort network staff promotion database 120E. This comparison may involve determining a number of promotions that were distributed by staff device 130 and that actually resulted in user participation as indicated by information sent from user device 140. Such comparison may further involve filtering the resort network user database 120F based on the promotion ID, the staff ID, the time arrived, as well as further involving determination as to the count of the used promotions and comparison to the information in the resort network staff promotion database 120E to determine which bonus the staff member achieved. In step 550, the staff reward is extracted and in step 555, stored in the resort network staff reward database 120C. In step 560, the resort network sever 120 connects to the staff device 130 and in step 565, sends the reward information maintained in the resort network staff reward database 120C to the staff device 130.

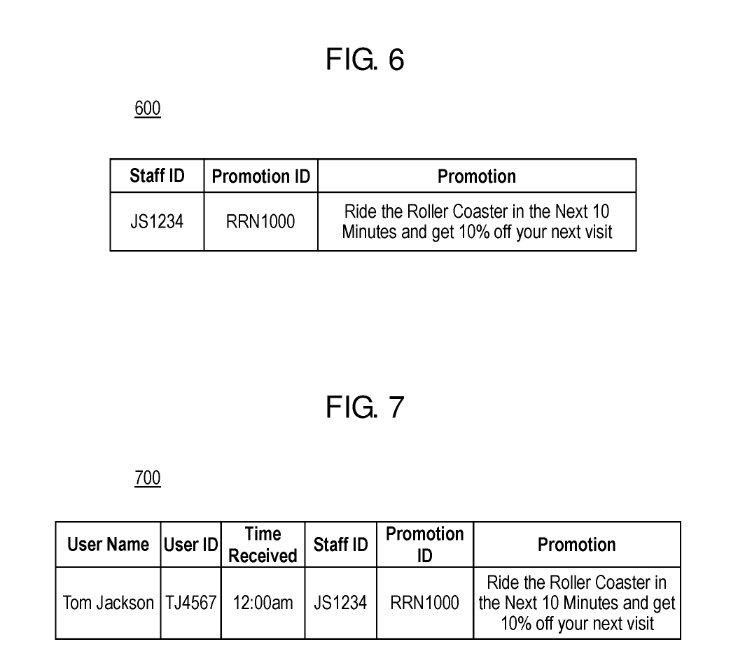

FIG. 6 illustrates an exemplary entry 600 from a staff device database 130B that may be used in a system for distributing promotions in association with digital ticketing. The entry 600 from staff device database 130B may be based on information entered at the staff device GUI 130C inputs and sent to the user device 140 from the staff device 140 that distributed the promotion and related details. The entry 600 from staff device database 130B may include the staff ID, promotion ID, and promotion description.

FIG. 7 illustrates an exemplary entry 700 from a user device database 140B that may be used in a system for distributing promotions in association with digital ticketing. The entry 700 from the user device database 140B may be based on the user inputs entered via the user device GUI 140C and data sent from the staff device 130. The entry 700 from the user device database 140B may include the user name, user ID, time received (e.g., from the staff device 130), staff ID, promotion ID, and promotion description.

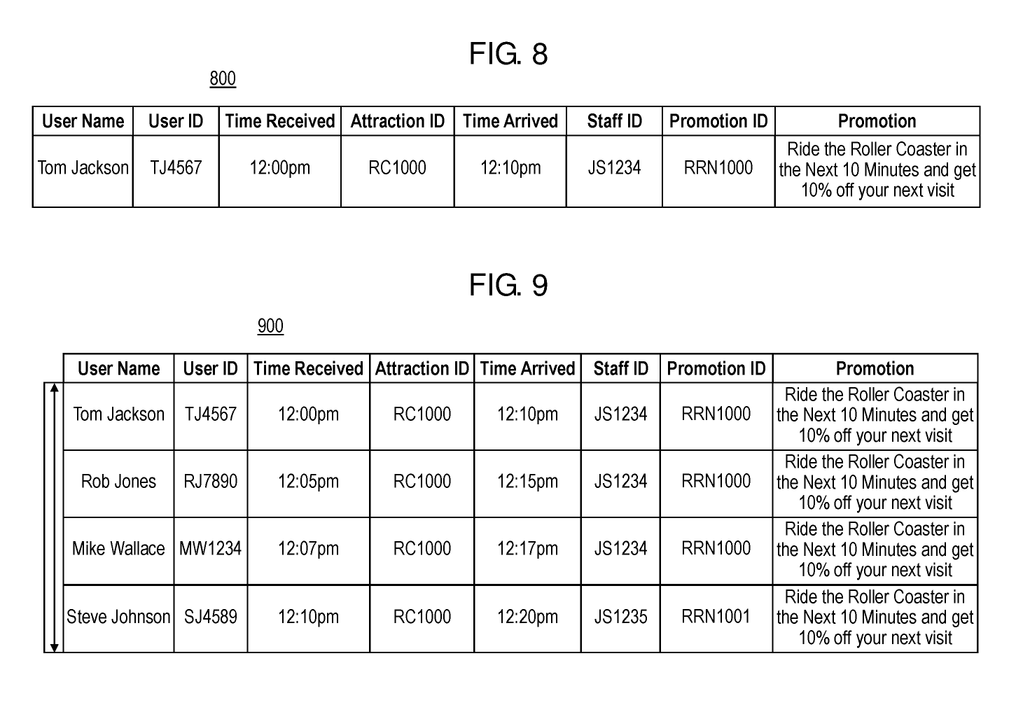

FIG. 8 illustrates an exemplary entry 800 from attraction network database 150B that may be used in a system for distributing promotions in association with digital ticketing. The entry 800 from the attraction network database 150B may be based on data received from the user device 140 and data from various automated attraction check-in or check-out or other beacon devices (e.g., location, time arrived, and attraction ID). The entry 800 from attraction network database 150B may include the user name, user ID, time received, attraction ID, time arrived, staff ID, promotion ID, and promotion description. The entry 800 from attraction network database 150B may be sent to the resort network server 120 for further evaluation in context with previously received data from the same or other attraction network servers 150.

FIG. 9 illustrates an exemplary set of entries 900 from a resort network user database 120F that may be used in a system for distributing promotions in association with digital ticketing.

The entries 900 from resort network user database 120F may be based on data received from the attraction network server 150 (and that was maintained at attraction network user database 150B) and represents a compilation of user data generated at the resort location. Such entries 900—which may be used to determine if the user or if the staff member achieved a promotion or bonus—may include the user name, user ID, time received, attraction ID, time arrived, staff ID, promotion ID, and promotion description.

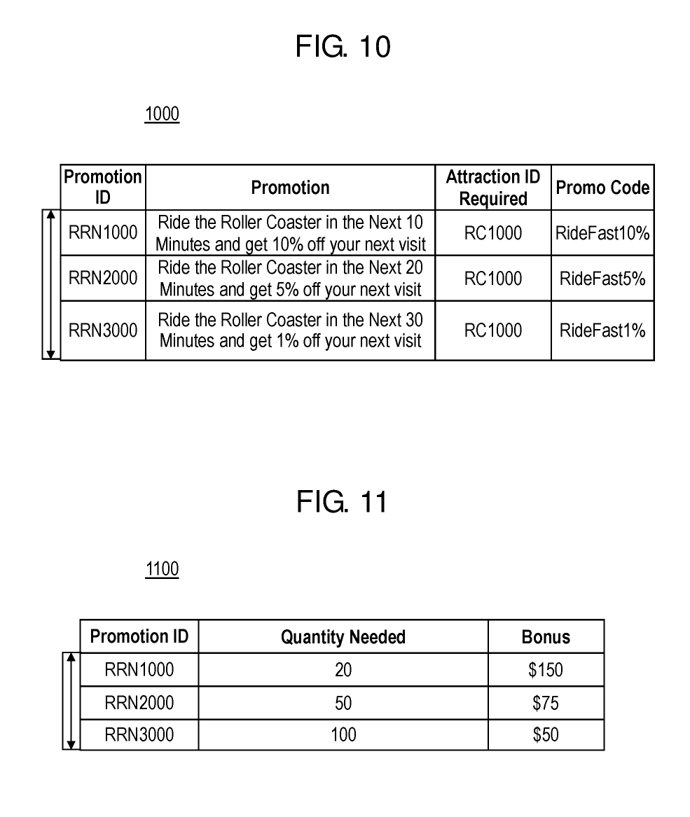

FIG. 10 illustrates an exemplary set of entries 1000 from a resort network user promotions database 120D that may be used in a system for distributing promotions in association with digital ticketing. The entries 1000 from the resort network user promotion database 120D may be used to determine if the data stored in the resort network user database 120F meets certain conditions that would qualify the user for a promotion reward. The entries 100 from resort network user promotion database 120D may include the promotion ID, promotion description, the attraction ID, and the promotion code for unlocking the promotion reward.

FIG. 11 illustrates an exemplary set of entries 1100 from a resort network staff promotions database 120E that may be used in a system for distributing promotions in association with digital ticketing. The entries 110 from the resort network staff promotion database 120E may be used to determine if the data currently stored in the resort network user database 120F allows a staff member to qualify for a reward (e.g., based on a number of promotions that were distributed, a number of promotions that actually prompted user activity as indicated by user device 140). The entries 1100 from the resort network staff promotion database 120E may include the promotion ID, quantity needed, and an associated bonus to be awarded upon meeting the quantity.

FIG. 12A illustrates an exemplary entry 1200A from a resort network user reward database 120B that may be used in a system for distributing promotions in association with digital ticketing. The entry 1200A from the resort network user reward database 120B may be based on a comparison of information stored in the resort network user database 120F to information stored at the resort network user promotion database 120D to identify achieved promotion rewards. The entry 1200A from resort network user reward database 120B may include the user name, user ID, attraction ID, promotion ID, promotion description, and promotion code for redeeming the promotion reward.

FIG. 12B illustrates an exemplary entry 1200B from a resort network staff reward database 120C that may be used in a system for distributing promotions in association with digital ticketing. The entry 1200B from the resort network staff reward database 120C may be based on a comparison of the information in the resort network user database 120F to the information stored in the resort network staff promotion database 120C to identify when the conditions of a promotion have been met. The entry 1200B from the resort network staff reward database 120C may include staff ID, promotion ID, quantity needed to achieve the bonus, and the bonus amount.

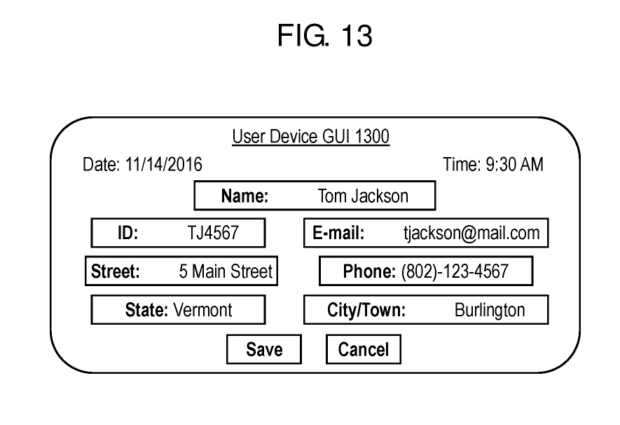

FIG. 13 illustrates an exemplary screenshot of a graphic user interface (GUI) 1300 used for input at a user device 140 that may be used in a system for distributing promotions in association with digital ticketing. The user device GUI 1300—which may correspond to user device GUI 140C—may be used to prompt user input (e.g., as part of registration, sign-up for specific notifications and promotions). The user device 1300 may include the date and time, as well as fields for inputting the user name, ID, e-mail address, street address, phone, state, and the city/town. The user device GUI 1300 may further include a “save” button that upon selection, confirms the inputs and results in storage in the user device database 120B.

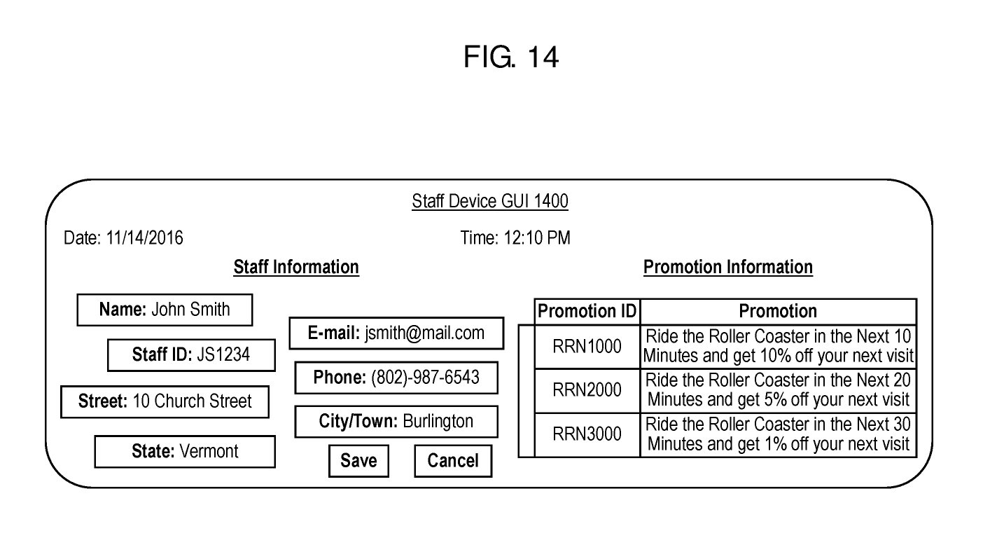

FIG. 14 illustrates an exemplary screenshot of a graphic user interface (GUI) 1400 used for input at a staff device 130 that may be used in a system for distributing promotions in association with digital ticketing. The staff device GUI 1400—which may correspond to staff device GUI 130C—may be used to prompt the staff member to input certain information. The staff device GUI 1400 may include the date and time, as well as fields for entering staff member name, ID, e-mail address, street address, phone, state, and the city/town. A “save” button may be selected to confirm the inputs for storage in the staff device database 130B.

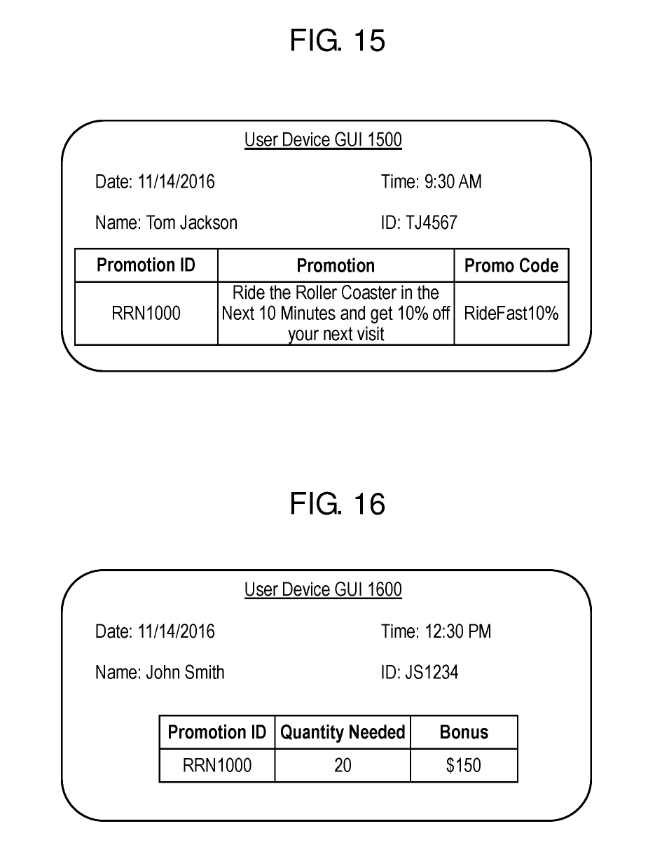

FIG. 15 illustrates an exemplary screenshot of a graphic user interface (GUI) 1500 used for displaying user rewards at a user device 140 that may be used in a system for distributing promotions in association with digital ticketing. The user device GUI 1500—which may correspond to user device GUI 140C—allow for information regarding various achieved rewards to be displayed. Such information may include that received from the resort network server 120 (as maintained in the resort network user rewards database 120B). The user device GUI 1500 may display the date and time, the user name and ID, the promotion ID, promotion description, and a promotional code for redeeming the reward.

FIG. 16 illustrates an exemplary screenshot of a graphic user interface (GUI) 1600 used for displaying staff rewards at a staff device 130 that may be used in a system for distributing promotions in association with digital ticketing. The staff device GUI 1500—which may correspond to staff device GUI 130C—may display information regarding bonuses earned by the staff member. Such information may be based on information received from the resort network server 120 (as maintained in the staff rewards database 120C). The staff device GUI 1600 may display the date and time, the staff member name and ID, the promotion ID, the quantity needed to achieve the bonus and the bonus amount.

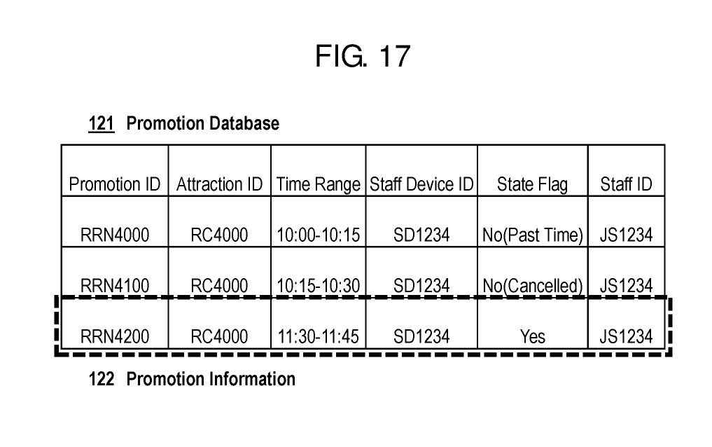

The resort network server 120 may include a promotion database 121 (FIG. 17). The promotion database 121 includes promotion information as to each of promotions. Each record of the promotion database 121 includes promotion information 122. The promotion information includes staff identifiers (Staff ID), promotion identifiers (Promotion ID) and promotion state flags (State Flag). The staff identifiers identify staff members. The staff member may be the person who distributes the promotions. The staff identifiers may indicate two or more members who are allowed to distribute promotions. The promotion identifier is a unique identifier to identify corresponding one of the promotions. Each promotion can be identified based on the promotion identifier.

The promotion state flag identifies which promotions of the record are now available. The staff device 130 is not always connected with the server (off-line). If the promotion information 122 can be updated when the staff device 130 is in off-line, the staff device 130 in off-line does not have the latest promotion information 122. If the staff device becomes in online and is allowed to distribute a promotion immediately, that staff device 130 may distribute a promotion which is not available. Accordingly, if there are a plurality staff device 130, each staff device may have a different version of promotion information 122. Therefore, in this example, the staff device 130 first acquires promotion information 122 including the promotion state flag from the server when the staff device 130 become online. When the promotion state flag shows that a certain promotion has been disabled, the staff device can stop distributing such a disabled promotion. The state flag allows the staff device to distribute promotion where the connection is not ensured.

The communication interface of the staff device 130 may be configured to receive the promotion information from the server. The communication interface of the staff device 130 supports communication between the staff device 130 and the server.

This example may include a plurality of staff devices 130 including a first staff device 130a and a second staff device 130b. In this configuration, the staff using the first staff device 130a can add a new promotion by sending the promotion information to the resort network server 120. When the server receives the promotion information from the first staff device 130a, the resort network server 120 sends the promotion information to the second staff device 130b other than the first staff device 130a. The second staff device 130b receives the promotion information from the resort network server 120. Therefore, the staff members can add and share the promotions.

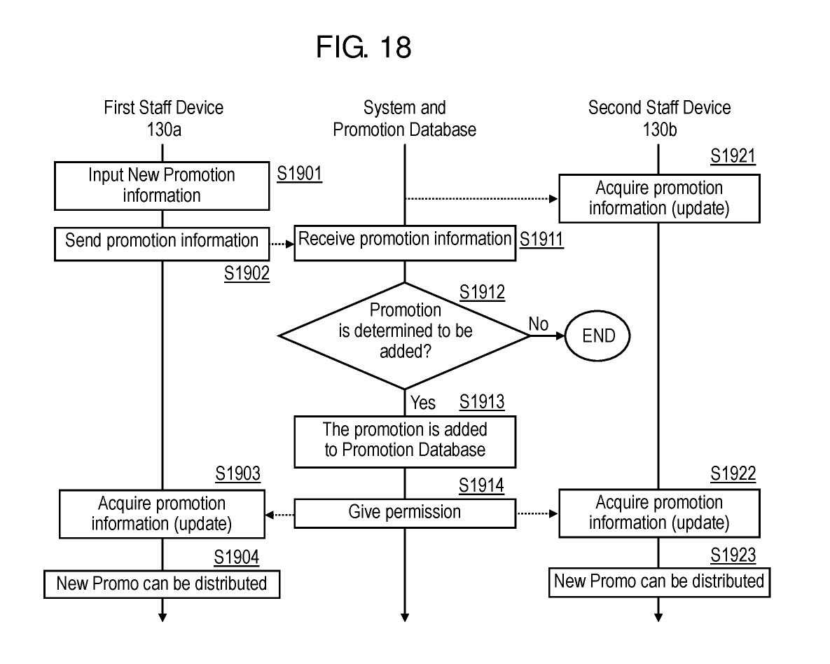

FIG. 18 shows a flow chart for avoiding a staff device from distributing a promotion which is now not available and for allowing all staff devices to have the latest promotion information. When the second staff device 130b becomes in online, the second staff device 130b acquires the latest promotion information 122 from the server in step S1921 so that the second staff device 130b can avoid sending a promotion which is now not available.

The promotion information 122 in this example may include target attraction information which identifies the attraction of the promotion and time range information which indicates time range of promotion information 122. The first staff device 130a inputs new promotion information in step S1901 and sends the promotion information 122 to the server in step S1901. The new promotion information may disable the state flag to make the recorded promotion information become unavailable. The server receives the promotion information 122 in step S1911, and determines whether the received promotion information 122 is already registered for the attraction of the promotion to the promotion database 121 according to the time range information in step S1912.

When the time range of the promotion information 122 to be registered is partially overlapped with one of the time range of the promotion already registered to the promotion database 121 (No in step S1912), the resort network server 120 does not register such promotion information to the promotion database 121. Therefore, the server may prevent double registration of promotion information to the promotion database 121.

On the other hand, when the time range of the promotion information 122 to be registered is not overlapped with any time range of the promotion information 122 already registered to the promotion database 121 (Yes in step S1912), the resort network server 120 (i) registers the received promotion information 122 to the promotion database 121 in step S1913, and (ii) gives permission to the first staff device to send the offer to one or more user devices 140. Therefore, the promotion information 122 to be registered is successfully added to the promotion database 121, and the first staff device 130a receives the updated promotion information 122 in step S1903 (the first staff device 130a does not necessarily receive the updated promotion information 122 because it has one) and is permitted to send the offer to user devices 140 in steps S1903 and S1904. At the same time, the second device 130b can acquire promotion information 122 from the server in step S1922 and distribute the same offer to the user devices 140 in step S1923.

In the configuration, the first stuff device 130a may add a new promotion by avoiding unreasonable double registration which may be caused by the conflict between the two stuff devices 130a and 130b.

According to another example, a system for distributing promotions can control the number of guests who can obtain the same promotion. In this example, in order to send a promotion to one guest, each staff device may need to obtain one ticket from the resort network server 120. Each staff device may need to obtain another ticket when sending the same promotion to another guest. As explained below, the staff device may maintain a plurality of tickets. Tickets may be valid for distributing promotions even though the staff device is not connected to the resort network server 120 or in off-line (that the staff device not connected to the resort network server 120 or in off-line means that the staff device not under control by the system can distribute promotions to guests). Accordingly, as long as the staff device has tickets for distributing a particular promotion to guests, the staff device can distribute that promotion to guest regardless of whether the staff device is in online, in this example.

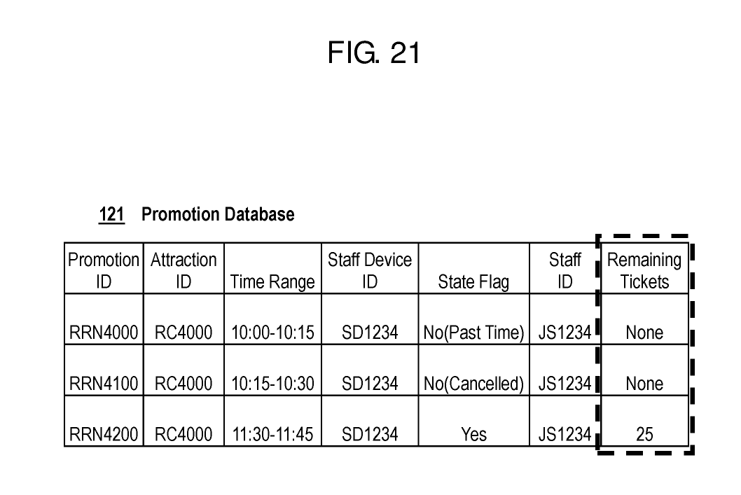

As shown in FIG. 21, the promotion database 121 may include information on how many tickets are available for each promotion (“remaining tickets”). Based on the information in the promotion database 121, the resort network server 120 can control how many times each promotion can be distributed to guests.

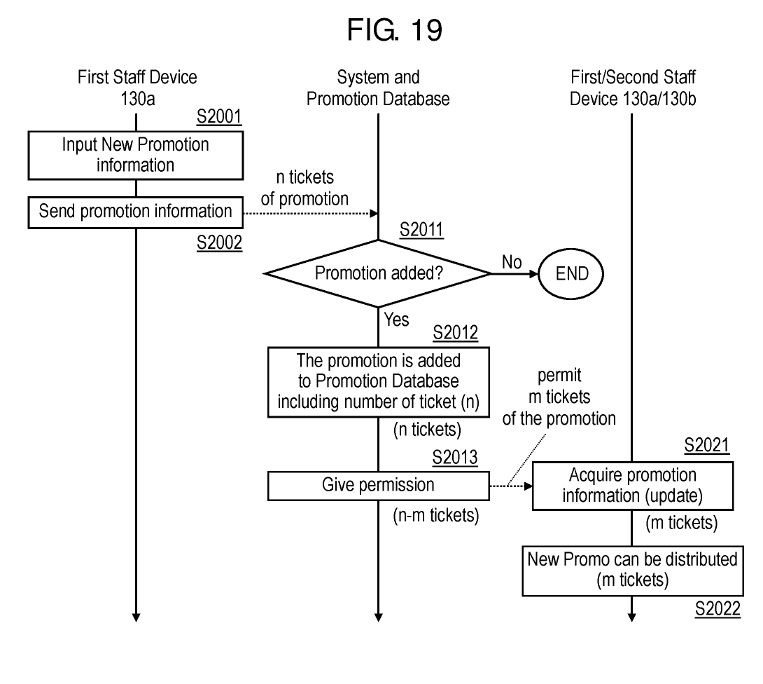

FIG. 19 shows an exemplary flow chart of controlling the number of tickets to be distributed to staff devices for a particular promotion. A staff member having the first staff device 130a (for example) can generate a new promotion information including information on how many times the new promotion can be distributed (S2001). In this example, n tickets (n: integer) are set by the staff member to determine how many times the new promotion can be distributed. The first staff device 130a then sends the promotion information to the resort network server 120 (S2002). After determining whether the promotion is added to the promotion database 120 (S2011) (see step S1912 of FIG. 18), the resort network server 120 adds to the promotion database 121 the promotion information including the information on how many tickets are available (the n tickets are available in this example) (S2012). When the resort network server 120 gives staff devices permission to distribute the corresponding promotion to guests (S2013), each staff device (e.g., first and second staff devices 130a and 130b) can take, for example, m tickets (m: integer) from the available tickets (S2021). Therefore, each staff device can distribute the corresponding promotion up to m times (S2022). Of course, each staff device may not necessarily take the same number of tickets as other staff devices.

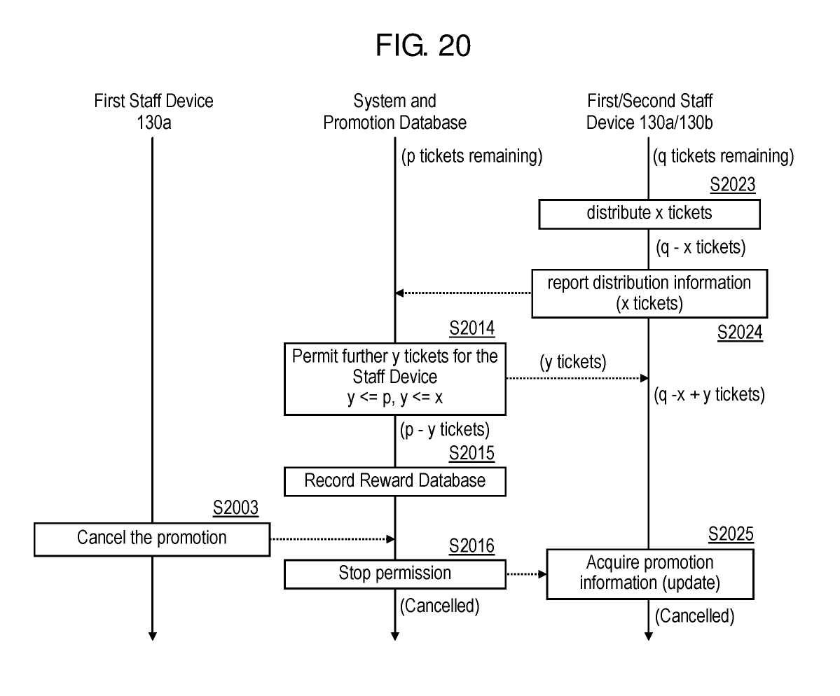

As shown in FIG. 20, the second staff device 130b (or first staff device 130a) is assumed to have q tickets (q: integer). For example, the second staff device 130b uses tickets from x tickets, and now q-x tickets remains in the second staff device 130b. When the second staff device 130b uses x tickets (x: integer) from the q tickets to distribute the promotion to guests x times (S2023) and the second staff device 130b is online, the second staff device 130b can report distribution information on how many tickets are used to the resort network server 120 (S2024). In this example, since the x tickets are used by the second staff device 130b after the previous report to the resort network server 120 (see S2024), the second staff device 130b has q-x tickets at S2024.

In this example, the promotion database 121 has p tickets (remaining tickets after the first staff device 130a takes m tickets and the second staff device 130b also takes m tickets, for example) for the promotion to be distributed to guests. When the resort network server 120 receives the distribution report from the second staff device 130b, the server may determine how many tickets can be given to the second staff device 130b based, for example, on the number of remaining tickets (p tickets) and how many tickets are used to distribute the promotion (x tickets) by the second staff device (S2014). For example, the number of tickets the resort network server 120 can now give the second staff device 130 is y (y: integer), where y may be smaller than p (the number of the remaining tickets in the promotion database 121), i.e., y≤p, and may be smaller than x (the number of tickets the second staff device 130b uses to distribute the promotion to guests) (y<x). If these conditions are met, the resort network server 120 can give additional y tickets to the second staff device 130b. Therefore, the remaining tickets of the promotion database 121 decrease to p-y tickets. The second staff device 130b receives the y tickets, and now has q-x+y tickets. The system also record user reward information to a reward database, for example, the user reward database 120B, based on the distribution report (S2015).

According to this example, any staff device, a staff device which has an administrator authority, or a staff device which sets promotion information, can cancel the promotion added to the promotion data base 121 at step S2011 in FIG. 19. For example, when the first staff device 130a may request the resort network server 120 to cancel the promotion (S2003), the server can stops the permission (S2016) so that each staff device can stop distributing the corresponding promotion regardless of how many tickets remains. If the second staff device 130b (for example) is in off-line when the resort network server 120 stops the permission at step S2016, the system may allow the second staff device 130b to continue to distribute the corresponding promotion to guests as long as the device has tickets, in this example. Through the tickets, the system can still limit how many times the second staff device 130b can distribute the promotion to guests even though the device is in off-line. The second staff device 130b may stop distribution of the promotion according to the time range of the promotion regardless of whether the second staff device 130b is off-line.

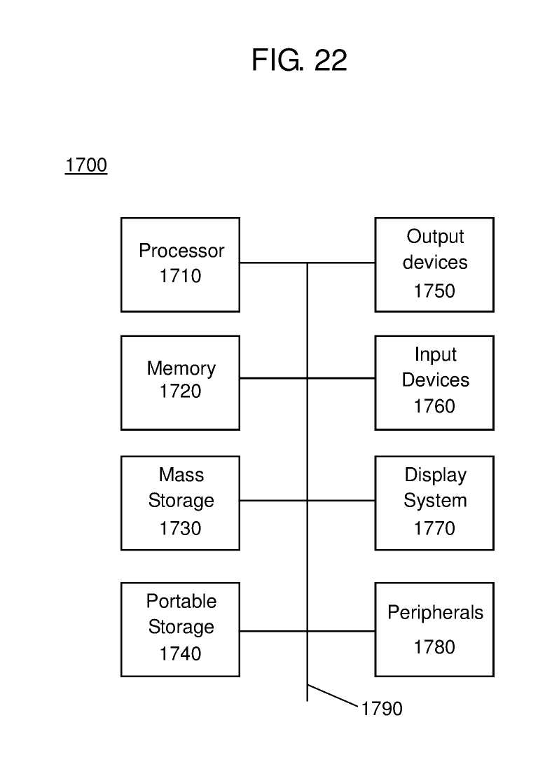

FIG. 22 illustrates an exemplary computing system 1700 that may be used to implement an embodiment of the present invention. The computing system 1700 of FIG. 17 includes one or more processors 1710 and memory 1720. Main memory 1720 stores, in part, instructions and data for execution by processor 1710. Main memory 1720 can store the executable code when in operation. The system 1700 of FIG. 17 further includes a mass storage device 1730, portable storage medium drive(s) 1740, output devices 1750, user input devices 1760, a graphics display 1770, and peripheral devices 1780.

The components shown in FIG. 17 are depicted as being connected via a single bus 1790. However, the components may be connected through one or more data transport means. For example, processor unit 1710 and main memory 1720 may be connected via a local microprocessor bus, and the mass storage device 1730, peripheral device(s) 1780, portable storage device 1740, and display system 1770 may be connected via one or more input/output (I/O) buses.

Mass storage device 1730, which may be implemented with a magnetic disk drive or an optical disk drive, is a non-volatile storage device for storing data and instructions for use by processor unit 1710. Mass storage device 1730 can store the system software for implementing embodiments of the present invention for purposes of loading that software into main memory 1720.

Portable storage device 1740 operates in conjunction with a portable nonvolatile storage medium, such as a floppy disk, compact disk or Digital video disc, to input and output data and code to and from the computer system 1700 of FIG. 17. The system software for implementing embodiments of the present invention may be stored on such a portable medium and input to the computer system 1700 via the portable storage device 1740.

Input devices 1760 provide a portion of a user interface. Input devices 1760 may include an alpha-numeric keypad, such as a keyboard, for inputting alpha-numeric and other information, or a pointing device, such as a mouse, a trackball, stylus, or cursor direction keys. Additionally, the system 1700 as shown in FIG. 17 includes output devices 1750. Examples of suitable output devices include speakers, printers, network interfaces, and monitors.

Display system 1770 may include a liquid crystal display (LCD) or other suitable display device. Display system 1770 receives textual and graphical information, and processes the information for output to the display device.

Peripherals 1780 may include any type of computer support device to add additional functionality to the computer system. For example, peripheral device(s) 1780 may include a modem or a router.

The components contained in the computer system 1700 of FIG. 17 are those typically found in computer systems that may be suitable for use with embodiments of the present invention and are intended to represent a broad category of such computer components that are well known in the art. Thus, the computer system 1700 of FIG. 17 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claim.

What is claimed is:

1. A system for distributing promotions in association with digital tickets, the system comprising:
a staff device comprising:
memory that stores information regarding a plurality of promotions, each promotion comprising at least one attraction and an associated reward, and
a communication interface that sends an offer to one or more communications device regarding at least one of the promotions and staff device identifier; and
a server comprising:
a communication interface that receives information from a communication device of one of the guests; and
a processor that executes instructions stored in memory, wherein execution by the instructions by the processor analyzes the received information to determine whether the guest has met a condition of the promotion at the attraction within a predetermined time and whether a staff member of the staff device has met a condition of one or more staff promotions;
wherein the communication interface transmits a notification to the communication device when the reward is achieved by the guest and a notification to the staff device when a staff reward is achieved by the staff member.

2. The system of claim 1, wherein
the server further comprises a promotion database including promotion information as to each promotion,
the promotion information includes:
a staff identifier which identifies the staff member;
a promotion identifier identifies promotions, respectively; and
a promotion state flag which indicates whether the promotion is available.

3. The system of claim 2, wherein
the communication interface of the staff device
receives the promotion information.

4. The system of claim 3, wherein
further includes:
a first staff device and a second staff device, which are the staff devices,
the first staff device sends the promotion information to the server via the communication interface of the first staff device,
the server
receives the promotion information, and
sends the promotion information to the second staff device,
the second staff device receives the promotion information via the communication interface of the second staff device.

5. The system of claim 4, wherein the promotion information further including:
target attraction information which identifies the attraction of the promotion; and
time range information which indicates time range of the promotion information, wherein,
when the first staff device sends the promotion information to the server,
the server determines whether the time range of the promotion information is already registered for the attraction of the promotion to the promotion database, wherein
when the time range of the promotion information to be registered is overlapped with one of the time range of the promotion information already registered to the promotion database, the server does not register the promotion information to the promotion database,
when the time range of the promotion information to be registered is not overlapped with the time range of the promotion information already registered to the promotion database, the server (i) registers the promotion information to the promotion database and (ii) gives permission to the first staff device to send the offer to one or more communications device.
